(19) United States
(12) Patent Application Publication
(10) Pub. No.: US 2009/0229397 A1
(43) Pub. Date: Sep. 17, 2009

(54) Protection Device For Speed Shifting Mechanism

(76) Inventor: Ting-Kuang Chen, Keelung (TW)

Correspondence Address: LIN & ASSOCIATES INTELLECTUAL PROPERTY, INC., P.O. BOX 2339, SARATOGA, CA, 95070-0339, US

(21) Appl. No.: 12/049,336

(22) Filed: Mar. 16, 2008

(51) Int. Cl. F16H 59/02

(52) U.S. Cl. 74/473.3

(57) ABSTRACT

A protection device for a speed shifting mechanism includes a case with a gear reduction unit received therein, and a tube is rotatably mounted to the case. The tube includes a plurality of positioning notches and a guide groove. A button mechanism includes an activation rod which is connected to the gear reduction unit and a shifter is connected to the activation rod. The shifter is engaged with the guide groove and a button is secured on the shifter. A control member includes a positioning plate which has a protrusion. The shifter is moved by operation of the button and the tube is rotated along with the movement of the shifter. When the protrusion is engaged with one of the positioning notches, the tube is locked and cannot rotate such that the shifter cannot be shifted unintentionally.

### BACKGROUND OF THE INVENTION

1. Field of the Invention

The present invention relates generally to a protection device for preventing unintentionally shift to a speed shifting mechanism of a power tool.

2. The Prior Arts

A conventional power tool such as a power screw driver generally includes a motor which provides power to drive an output shaft on which a bit is connected. In order to provide proper speed for different tasks, a gear reduction unit is used to regulate the high revolutions of the motor and connected to the output shaft. Generally, the conventional power tools includes high speed, constant speed and low speed operation modes for different requirements of the tasks and a switch is located on outside of the power tool so that the user can shift the switch to choose desired gear.

Besides, there is a button to control the power and when the user pushes the button, the motor is activated and provides power to the tool, and if the button is not pushed, the tool is not activated. Nevertheless, the switch for shifting gears of the conventional power tools do not have such protection button so that when the motor is activated, the switch is not protected so that the switch might be shifted unintentionally. The speed of the output shaft is then suddenly changed during operation and this may cause damage to the objects or even the users.

The present invention provides a protection device which locks the switch so that even when the switch is touched unintentionally, the gear does not change so as to protect the tool, the object and the user.

### SUMMARY OF THE INVENTION

A primary objective of the present invention is to provide a protection device which improves the shortcoming of the conventional power tool whose switch for shifting gears cannot be locked and may be unintentionally shifted to damage the objects.

The protection device includes a tube rotatably mounted to a case of a power tool and a shifter of the protection device is connected to the tube which is rotated when the shifter is shifted. A control member includes a positioning plate from which a protrusion extends and the protrusion is engaged with one of positioning notches defined in the tube so as to lock the tube to prevent the tube from rotation when the switcher is unintentionally touched.

The protection device of the presenting invention includes a case with a gear reduction unit received therein and a slot is defined through the case. A tube is rotatably mounted to the case and includes a plurality of positioning notches. A guide groove is defined through the tube. A button mechanism comprises an activation rod, a shifter and a button, in which the activation rod is connected to the gear reduction unit via the slot, and the shifter is engaged with the guide groove and connected to the activation rod. The button is secured on the shifter. A control member comprises a positioning plate which has a protrusion and the protrusion is engaged with one of the positioning notches to lock the tube. When the protrusion is disengaged from the positioning notch, the tube can be rotated for shifting the shifter.

According to the present invention, the button mechanism is well protected and the purpose for preventing unintentional shifting is achieved.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a partial cross sectional view to show a power tool with a protection device in accordance with the present invention;

FIG. 2A is a perspective view to show a button of the protection device in accordance with the present invention;

FIG. 2B shows a shifter of the protection device in accordance with the present invention;

FIG. 2C shows a guide groove of a tube of the protection device in accordance with the present invention;

FIG. 2D shows an activation rod of the protection device in accordance with the present invention, and

FIG. 3 shows positioning notches in the tube and a control member includes a positioning plate with a protrusion.

### DETAILED DESCRIPTION OF THE PREFERRED EMBODIMENT

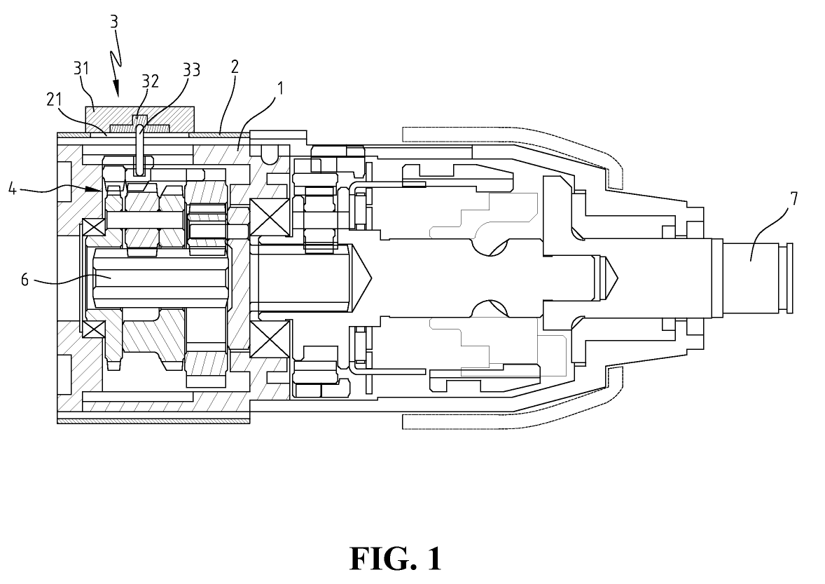

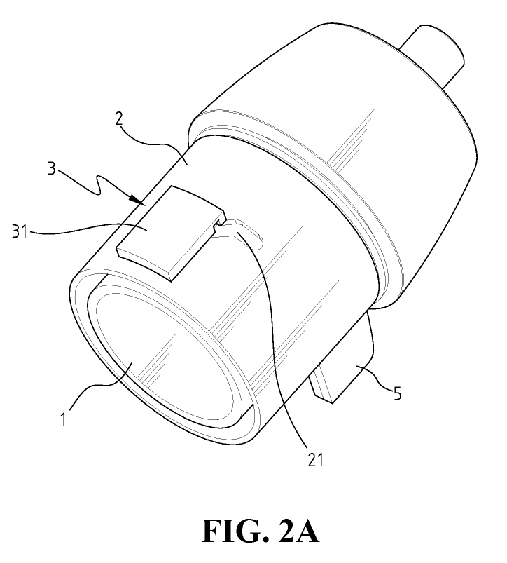

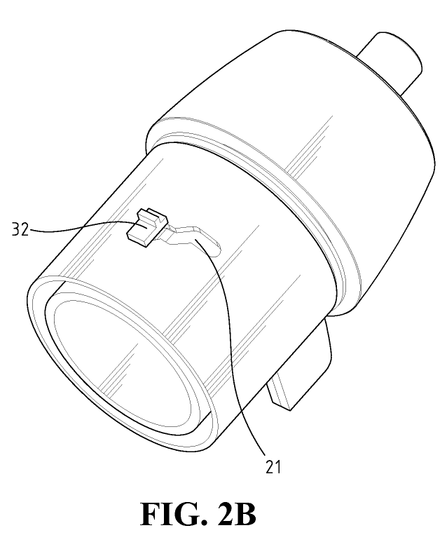

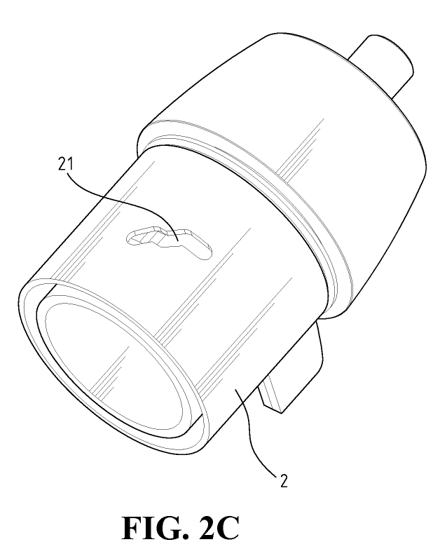

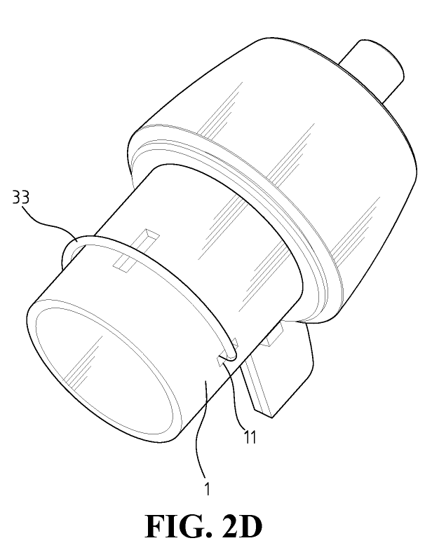

With reference to the drawings and in particular to FIGS. 1 and 2A, a protection device for a speed shifting mechanism in accordance with the present invention comprises a case 1 with a gear reduction unit 4 received therein and the gear reduction unit 4 includes a planet gear system and multiple types of gears. A motor gear 6 is driven by a motor (not shown) and the gear reduction unit 4 changes the speed from the motor and the speed is then transferred to the output shaft 7.

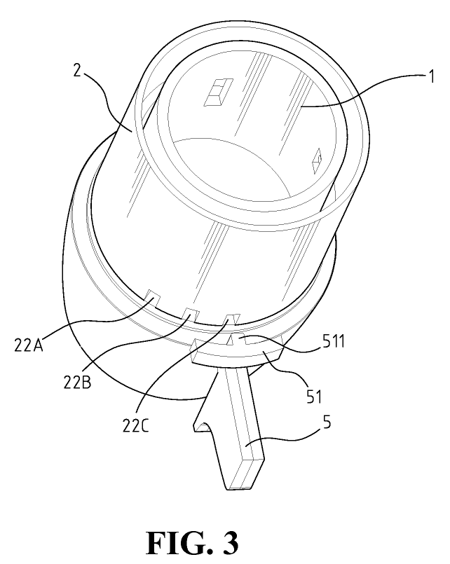

The gear reduction unit 4 is connected to a button mechanism 3 as shown in FIG. 2D and the button mechanism 3 includes an activation rod 33 whose two ends are inserted into the two slots 11 defined through the case 1 and connected to the gear reduction unit 4. A tube 2 as shown in FIG. 2C is rotatably mounted to the case 1 and a guide groove 21 is defined through the tube 2. A plurality of positioning notches 22A, 22B and 22C are defined on a periphery of the tube 2. If the power tool includes three gears which are high speed, constant speed and low speed, there are three positioning notches 22A, 22B and 22C for the three gears as shown in FIG. 3. A shifter 32 is engaged with the guide groove 21 and is connected with the activation rod 33 as shown in FIG. 2B and a button 31 is connected to the shifter 32 as shown in FIG. 2A.

FIG. 3 shows that a control member 5 is connected to the power tool so as to control the activation of the motor. The control member 5 comprises a positioning plate 51 which has a protrusion 511. The protrusion 511 is engaged with one of the positioning notches 22A, 22B and 22C to lock the tube 2.

When the control member 5 is not yet pushed, the motor is not activated, the protrusion 511 on the positioning plate 51 is not engaged with any of the positioning notches 22A, 22B and 22C, and the tube 2 is freely rotatable, the user can shift the button 31 to move the shifter 32 and the activation rod 33 to shift the gears. The shifter 32 is engaged with the guide groove 21 so that when the shifter 32 is moved, the tube 2 is rotated along with the movement of the shifter 32. When the power tool is set to high speed, the protrusion 511 is engaged with the positioning notch 22A. When the power tool is set to constant speed, the protrusion 511 is engaged with the positioning notch 22B. When the power tool is set to low speed, the protrusion 511 is engaged with the positioning notch 22C. When the user pushes the control member 5 to activate the motor, the protrusion 511 is engaged with one of the positioning notches 22A, 22B or 22C to lock the tube 2. In other words, tube 2 cannot be rotated even if the button 31 is unintentionally pushed so that the gear reduction unit 4 in the case 1 is protected.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A protection device for a speed shifting mechanism, comprising
a case having a gear reduction unit received therein and a slot defined through the case;
a tube rotatably mounted to the case and including a plurality of positioning notches, a guide groove defined through the tube;
a button mechanism comprising an activation rod, a shifter and a button, the activation rod connected to the gear reduction unit via the slot and the shifter engaged with the guide groove and connected to the activation rod, the button secured on the shifter, and
a control member comprising a positioning plate which has a protrusion, the protrusion being engaged with one of the positioning notches to lock the tube.
